(19) United States
(12) Patent Application Publication
(10) Pub. No.: US 2021/0191306 A1
(43) Pub. Date: Jun. 24, 2021

(54) RECORDING MEDIUM CONVEYANCE DEVICE AND IMAGE FORMING APPARATUS INCORPORATING THE RECORDING MEDIUM CONVEYANCE DEVICE

(71) Applicant: Hideki TOBINAGA, Kanagawa (JP)

(72) Inventor: Hideki TOBINAGA, Kanagawa (JP)

(21) Appl. No.: 17/117,710

(22) Filed: Dec. 10, 2020

(30) Foreign Application Priority Data
Dec. 24, 2019 (JP) 2019-232875

(51) Int. Cl. G03G 15/00; G03G 21/16

(52) U.S. Cl. CPC G03G 15/6558; G03G 2215/00679; G03G 21/1633

(57) ABSTRACT

A recording medium conveyance device includes a conveyance device cover, a pair of guides, a maintenance part, a removable cover. The conveyance device cover is openable and covers a conveyance passage of a recording medium. The pair of guides forms the conveyance passage and includes a cover side guide on the conveyance device cover and a body side guide separable from the cover side guide. The maintenance part is on at least one of the pair of guides. The removable cover is configured to form a part of the conveyance passage and cover the maintenance part.

### CROSS-REFERENCE TO RELATED APPLICATION

This patent application is based on and claims priority pursuant to 35 U.S.C. § 119 to Japanese Patent Application No. 2019-232875, filed on Dec. 24, 2019 in the Japan Patent Office, the entire disclosure of which is hereby incorporated by reference herein.

### BACKGROUND

### Technical Field

Embodiments of the present disclosure generally relate to a recording medium conveyance device and an image forming apparatus incorporating the recording medium conveyance device.

### Background Art

Some image forming apparatuses such as copiers, printers, and facsimiles include a vertical conveyance device that vertically conveys a recording medium (hereinafter, also referred to as “sheet”) from a sheet feeder to an image forming section. Such an image forming apparatus includes a cover that covers a sheet conveyance passage and is openable to facilitate jam processing.

### SUMMARY

This specification describes an improved recording medium conveyance device that includes a conveyance device cover, a pair of guides, a maintenance part, a removable cover. The conveyance device cover is openable and covers a conveyance passage of a recording medium. The pair of guides forms the conveyance passage and includes a cover side guide on the conveyance device cover and a body side guide separable from the cover side guide. The maintenance part is on at least one of the pair of guides. The removable cover is configured to form a part of the conveyance passage and cover the maintenance part.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a schematic view illustrating an image forming apparatus according to an embodiment of the present disclosure;

FIG. 2 is a schematic view illustrating an image forming apparatus of FIG. 1 when a conveyance device cover is opened;

FIG. 3 is an exploded perspective view illustrating a maintenance part, a cover of the maintenance part, and a guide to which the maintenance part and the cover are fixed according to an embodiment of the present disclosure;

FIG. 4 is a schematic cross-sectional view illustrating an example of the cover attached to the guide in a different way from the cover in FIG. 3;

FIG. 5 is a schematic cross-sectional view illustrating another example of the cover attached to the guide in a different way from FIGS. 3 and 4;

FIG. 6 is a schematic cross-sectional view of a vertical configuration of a conveyance passage according to an embodiment of the present disclosure;

FIG. 7 is a perspective view of a guide on an image forming apparatus side in the conveyance passage of FIG. 6;

FIG. 8 is a perspective view illustrating a part of the conveyance passage of FIG. 6;

FIG. 9 is a schematic cross-sectional view of a vertical configuration of a conveyance passage according to an embodiment of the present disclosure;

FIG. 10 is a schematic cross-sectional view of a vertical configuration of a conveyance passage according to an embodiment of the present disclosure;

FIG. 11 is a perspective view illustrating the guide to which the cover is not attached;

FIG. 12 is a perspective view illustrating the cover and rollers of a conveyance roller pair;

FIG. 13 is a schematic cross-sectional view of the guide, the rollers of the conveyance roller pair, and the cover in a recording medium conveyance direction; and

FIG. 14 is a schematic cross-sectional view illustrating still another example of the cover attached to the guide according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Although the embodiments are described with technical limitations with reference to the attached drawings, such description is not intended to limit the scope of the disclosure, and all of the components or elements described in the embodiments of this disclosure are not necessarily indispensable.

A description is provided of a recording medium conveyance device according to the present disclosure and an image forming apparatus incorporating the recording medium conveyance device with reference to drawings. It is to be noted that the present disclosure is not to be considered limited to the following embodiments, but can be changed within the range that can be conceived of by those skilled in the art, such as other embodiments, additions, modifications, deletions, and the scope of the present disclosure encompasses any aspect, as long as the aspect achieves the operation and advantageous effect of the present disclosure.

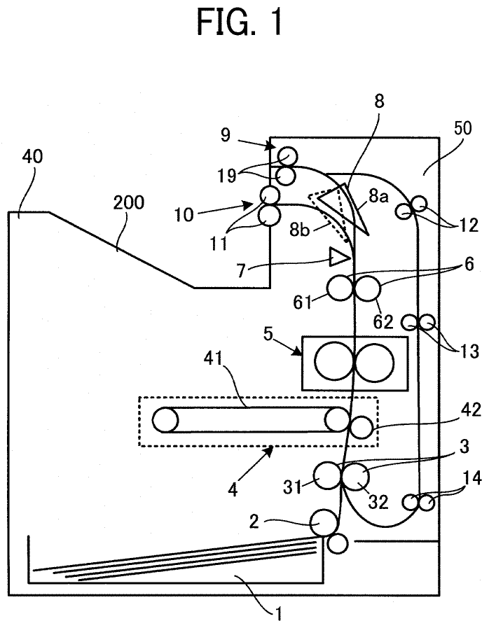

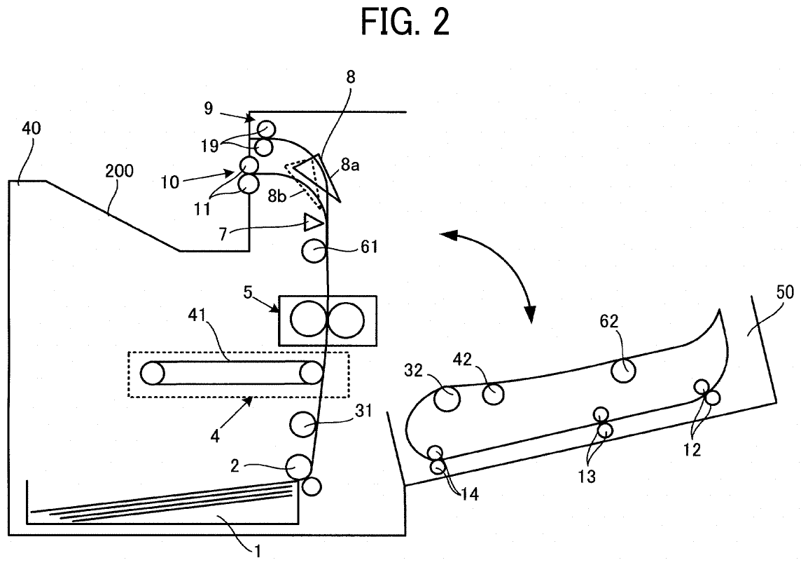

With reference to FIGS. 1 and 2, the image forming apparatus is described.

FIGS. 1 and 2 are schematic views illustrating the image forming apparatus including the recording medium conveyance device according to the present embodiment and illustrate a recording medium conveyance passage. Recording media are set in a recording media tray 1. Hereinafter, the recording medium is also simply referred to as a “sheet”. A feed roller 2 separates the sheet from the sheets in the recording media tray 1 and feeds the sheet to a registration roller pair 3. After the registration roller pair 3 holds the sheet for a predetermined time, the sheet is conveyed to an image forming section 4, and an image is transferred to the sheet in the image forming section 4. The image forming section 4 includes a transfer belt 41 and a transfer roller 42.

Next, the sheet is conveyed to a fixing device 5 to fix the image transferred to the sheet, and after the transferred image is fixed onto the sheet, the sheet passes through a conveyance roller pair 6 and is conveyed to a sheet ejection device 10 or a reverse unit 9. The conveyance roller pair 6 includes drive rollers 61 and driven rollers 62.

A bifurcating claw 8 switches whether the sheet which the image is fixed is conveyed to the sheet ejection device 10 or the reverse unit 9. In the recording medium conveyance device according to the present embodiment, the bifurcating claw 8 at a position 8a leads the sheet to the sheet ejection device 10, and the bifurcating claw 8 at a position 8b leads the sheet to the reverse unit 9. The bifurcating claw 8 is described later.

The sheet ejection device 10 ejects the sheet to a sheet ejection tray 200. The ejected sheet may be conveyed to a post-processing peripheral device such as a stapler to perform post-processing such as binding processing, sheet folding processing.

On the other hand, in the reverse unit 9, after a reverse roller pair 19 rotates in forward, the reverse roller pair 19 rotates in reverse to convey the sheet to a duplex copy unit. In the image forming apparatus of the present embodiment, a duplex copy entrance roller pair 12, a duplex copy relay roller pair 13, and a duplex copy exit roller pair 14 convey the sheet to the registration roller pair 3 again.

Downstream from the conveyance roller pair 6, a sheet ejection sensor 7 serving as a recording medium detector is disposed. The sheet ejection sensor 7 detects the sheet to output a trigger signal for switching the position of the bifurcating claw 8 or starting drive of the reverse roller pair 19 in the reverse unit 9 or the ejection roller pair 11 in the sheet ejection device 10.

As illustrated in FIG. 2, a conveyance device cover 50 is opened toward outside of the image forming apparatus body 40 to expose a conveyance passage in which the sheet is conveyed in a vertical direction. In FIG. 2, the sheet conveyance passage is from the registration roller pair 3 to the bifurcating claw 8. Exposing the conveyance passage enables easily performing jam processing or maintenance works for parts disposed on the conveyance passage. Note that FIG. 2 illustrates an example in which the conveyance device cover 50 is integrally rotated in the vertical direction to expose the conveyance passage, but the mode of rotation is not limited to this.

Next, the recording medium conveyance device is described.

The image forming apparatus of the present embodiment includes the recording medium conveyance device according to the present embodiment of the present disclosure to form the above-described conveyance passage for the recording medium (the sheet).

The recording medium conveyance device of the present embodiment includes a pair of guides to form the conveyance passage for the recording medium, a roller to convey the recording medium along the conveyance passage, and the conveyance device cover 50 that is disposed on a side face of the image forming apparatus body 40 to be able to open and close. The conveyance device cover 50 covers a part of the conveyance passage.

The conveyance device cover 50 can rotate to the outside of the image forming apparatus body 40 about a shaft parallel to the rotation axis of the roller (for example, the conveyance roller pair 6 in FIG. 1).

The pair of guides includes a guide on an image forming apparatus body side that is referred to as a body side guide and a guide on a conveyance device cover side that is referred to as a cover side guide. At least one of the body side guide and the cover side guide includes a maintenance part to be maintained and a cover that covers the maintenance part and forms the conveyance passage.

In the above-described configuration, removing the cover enables easy access to the maintenance part, attaching the maintenance part to the guide, and detaching the maintenance part from the guide. In addition, the cover forming a part of the guide reduces the number of parts and the number of work processes such as manufacturing processes and improves workability.

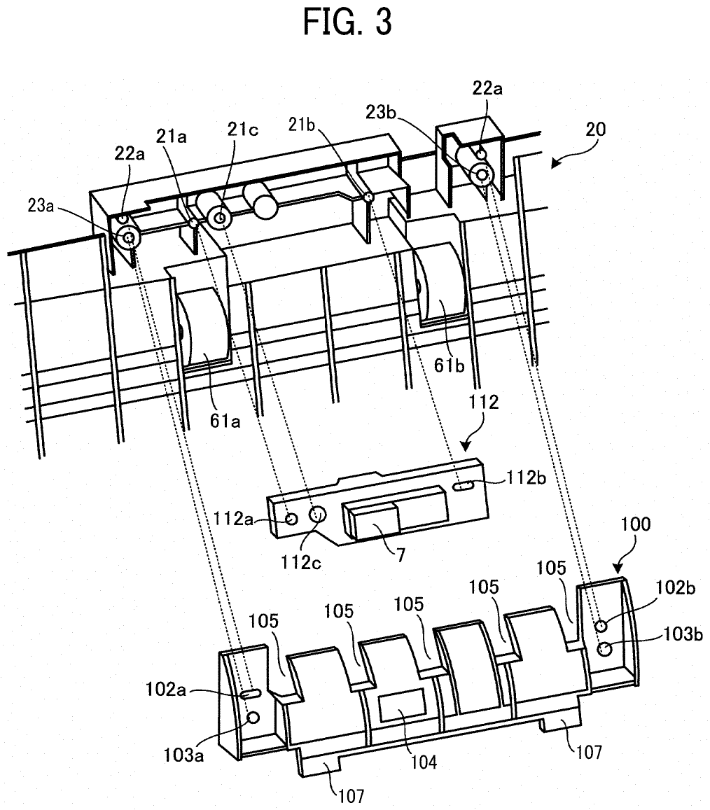

FIG. 3 is an exploded perspective view illustrating the maintenance part, the cover of the maintenance part, and the guide to which the maintenance part and the cover are fixed. The guide illustrated in FIG. 3 is the body side guide 20. Examples of the maintenance parts include parts to be maintained, such as rollers and electrical parts.

With reference to FIG. 3, the following describes an embodiment in which the maintenance part is an electrical part, specifically, a recording medium detector to detect the recording medium. The recording medium detector is also referred to as a sheet ejection sensor. The sheet ejection sensor 7 and a bracket 112 constitute a sheet ejection detecting device. A harness is connected to the sheet ejection sensor 7.

The bracket 112 has positioning holes 112a and 112b and a screwing hole 112c that may be a through hole or a threaded hole. The body side guide 20 includes bosses 21a and 21b. The boss 21a is inserted into the positioning hole 112a, the boss 21b is inserted into the positioning hole 112b, and the bracket 112 is positioned. The body side guide 20 includes a threaded hole 21c that communicates with the screwing hole 112c of the bracket 112, and a screw fixies the bracket 112 to the body side guide 20.

The cover 100 (hereinafter, also referred to as a “sensor cover 100”) is a removable member that covers the sheet ejection detecting device and forms the conveyance passage. The sensor cover 100 has a window 104 overlapping the sheet ejection sensor 7, positioning holes 102a and 102b, and screwing holes 103a and 103b. The positioning hole 102a is an elongated hole, and the positioning hole 102b mainly positions the sensor cover 100. The screwing holes 103a and 103b may be threaded holes or through holes.

The body side guide 20 includes positioning pins 22a and 22b. The positioning pin 22a is inserted into the positioning hole 102a, the positioning pin 22b is inserted into the positioning hole 102b, and the sensor cover 100 is positioned. The body side guide 20 includes threaded holes 23a and 23b that communicate with the screwing holes 103a and 103b, respectively, of the sensor cover 100, and screws fix the sensor cover 100 to the body side guide 20.

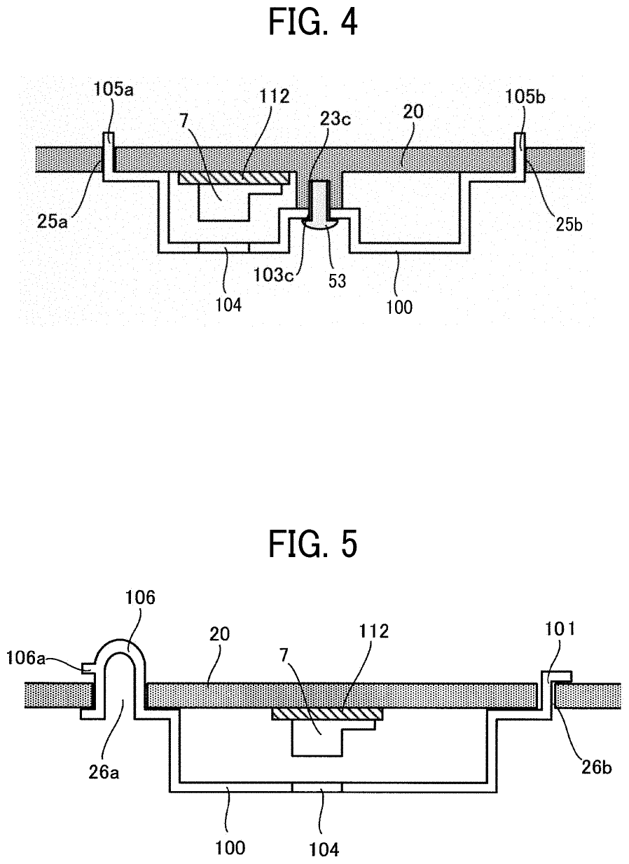

FIGS. 4 and 5 are schematic cross-sectional views illustrating the cover 100 attached to the body side guide 20 in different ways form the above-described cover 100. In the embodiment illustrated in FIG. 4, the sensor cover 100 includes detents 105a and 105b and a screwing hole 103c. The body side guide 20 includes positioning holes 25a and 25b. The detents 105a and 105b of the sensor cover 100 are fitted to the positioning holes 25a and 25b, respectively. The body side guide 20 includes a threaded hole 23c that communicates with the screwing hole 103c of the sensor cover 100, and a screw 53 fixies the sensor cover 100 to the body side guide 20. Reducing the number of fixing points with screws improves workability.

In the embodiment illustrated in FIG. 5, the sensor cover 100 includes a coupling part 101 and an elastic fixing member 106 having elasticity and a U-shaped cross-section.

The body side guide 20 includes a positioning hole 26a. The elastic fixing member 106 of the sensor cover 100 is inserted into the positioning hole 26a, and a fixing projection 106a of the elastic fixing member 106 fixes the elastic fixing member 106 on the body side guide 20. The body side guide 20 includes a positioning hole 26b. The coupling part 101 is inserted into and fitted to the positioning hole 26b of the body side guide 20 to fix the sensor cover 100 on the body side guide 20.

The conveyance device in the embodiment of FIG. 5 can be easily handled even when the space for attaching and detaching the sheet ejection sensor 7 is small (for example, when the conveyance device cover 50 rotates in a narrow range and forms a narrow opening angle) because the sensor cover 100 is attached to the body side guide 20 without using the screw.

FIG. 14 is a schematic cross-sectional view illustrating an embodiment in which the bracket 112 is set on the sensor cover 100. Other than a configuration to fix the bracket 112 on the sensor cover 100, a configuration in FIG. 14 are similar to the configuration in FIG. 5.

In the embodiment illustrated in FIG. 14, the bracket 112 is disposed on the sensor cover 100 so that a screwing hole 112d of the bracket 112 communicates with the threaded hole 109 disposed inside the sensor cover 100, and a screw 51 fastens the bracket 112 to the sensor cover 100.

In the embodiments of FIGS. 3 to 5, after the detachable sensor cover 100 is removed, the bracket 112 attached to the body side guide 20 is removed from the body side guide 20. In contrast, in the embodiment illustrated in FIG. 14, after the sensor cover 100 is removed from the body side guide 20, the bracket 112 is removed from the sensor cover 100. That is, since the work of removing the bracket 112 from the sensor cover 100 can be performed at an arbitrary place outside the image forming apparatus, workability is improved.

As described above, it is preferable that the maintenance part is integrally attached to the cover. The above-described configuration can improve the workability and accuracy for positioning the maintenance part attached to the cover. In addition, since the above-described configuration can reduce the number of parts, the above-described configuration can reduce the accumulation of tolerance as well as the cost.

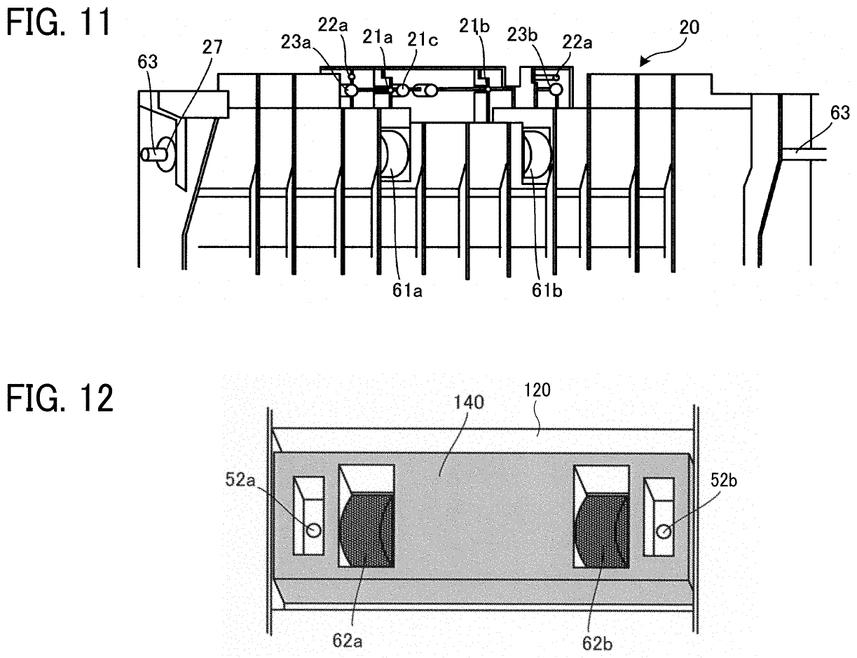

FIG. 11 is a perspective view illustrating the body side guide 20 to which the cover 100 is not attached.

As illustrated in FIG. 11, the body side guide 20 incudes drive rollers 61 of the conveyance roller pair 6 (that is, drive rollers 61a and 61b). In addition, the body side guide 20 has mounting holes 27 to set a conveyance roller rotation shaft 63 on both side faces of the body side guide 20 in a width direction.

Since the plurality of members are integrally formed as described above, the positioning accuracy and the mounting accuracy can be improved.

The cover 100 (that is, the sensor cover 100) is disposed near and downstream from the drive rollers 61 of the conveyance roller pair 6 in a recording medium conveyance direction. As illustrated in FIGS. 3 and 10, scoops 107 are preferably formed on the cover 100. When the scoop 107 is disposed downstream from a roller, forming the scoop 107 on the cover 100 improves the positional accuracy between the scoop 107 and the roller.

FIG. 10 is a schematic vertical cross-sectional view to describe the scoop 107. An end portion of the cover 100 may catch the recording medium conveyed on the conveyance passage and cause a jam. To prevent such a jam, the scoop 107 is formed so that the end portion of the cover 100 is curved so as to be separated from a surface forming the conveyance passage. The scoop 107 integrally formed with the cover 100 can reduce the number of parts.

With reference to FIG. 7, the body side guide 20 to form the conveyance passage in the image forming apparatus side is described.

The body side guide 20 includes a first guide member 20a on a lower portion than the cover 100 in a vertical direction and a second guide member 20b on an upper portion than the cover 100 in the vertical direction. That is, in the recording medium conveyance direction, the first guide member 20a is disposed upstream from the cover 100, and the second guide member 20b is disposed downstream from the cover 100.

Each of the first guide member 20a, the second guide member 20b, and the cover 100 includes a plurality of ribs extending in the recording medium conveyance direction. Each of the first guide member 20a, the second guide member 20b, and the cover 100 may include a plurality of convex portions extending in the recording medium conveyance direction. The plurality of ribs is an example of the plurality of convex portions. The cover 100 has notches 105 (see FIG. 3). The notch 105 can accommodate at least a part of a rib 208 of the second guide member 20b.

As illustrated in FIG. 7, a plurality of ribs is formed at intervals in a direction orthogonal to the recording medium conveyance direction. Each of the ribs 208 in the second guide member 20b is disposed along a direction of a line extended from each of the ribs 108 of the cover 100 and a direction of a line extended from each of the ribs 28 of the first guide member 20a, respectively. The plurality of ribs forms the surface of the conveyance passage and enables smooth conveyance of the recording medium.

The second guide member 20b is formed on a swing member to swing so that each of the ribs 208 enter and exit from the notch 105 of the cover 100. In the present embodiment, the swing member is the bifurcating claw 8 to switch the conveyance passage of the recording medium.

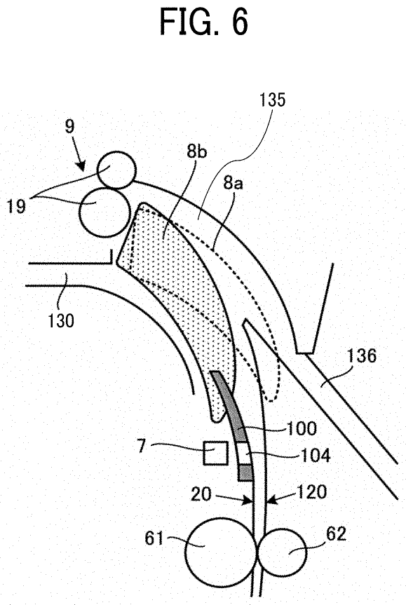

FIG. 6 is a schematic cross-sectional view of a vertical configuration of the conveyance passage.

After the recording medium passes through the fixing device 5 (see FIG. 1), the recording medium passes through the conveyance roller pair 6, passes between the pair of guides including the body side guide 20 and the cover side guide 120, and reaches the bifurcating claw 8.

The bifurcating claw 8 at the position 8a in FIG. 6 leads the recording medium to a sheet ejection passage 130. In contrast, the bifurcating claw 8 at the position 8b in FIG. 6 leads the recording medium to a reverse passage 135. The recording medium is sent from the reverse passage 135 to the reverse unit 9. In the reverse unit 9, the reverse roller pair 19 rotates forward to convey the recording medium by a predetermined amount and rotates in reverse to convey the recording medium to a duplex copy passage 136.

As illustrated in FIGS. 3 and 7, the cover 100 has five notches 105. As illustrated in FIGS. 6 and 7, the bifurcating claw 8 at the position 8b is in the notch 105. The bifurcating claw 8 swings so as to protrude to the outside of the notch 105 at the position of 8a.

The notch 105 eliminates the need for another part to connect the conveyance passage between the bifurcating claw 8 and the cover 100 and enables downsizing the recording medium conveyance device. In addition, the notch 105 enables arranging the sheet ejection sensor 7 closer to the bifurcating claw 8, which improves the detection performance of the sheet ejection sensor 7. The number of notches 105 accommodating the bifurcating claw 8 is not limited to five in the present embodiment and can be appropriately set.

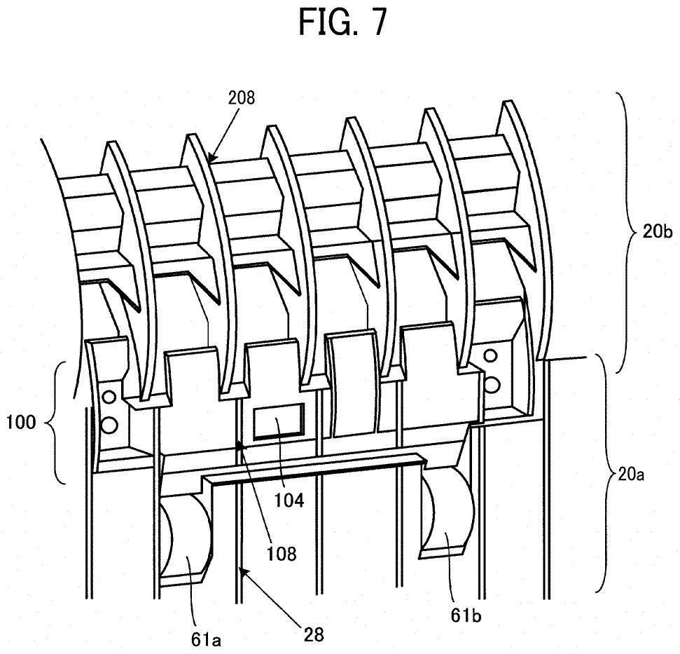

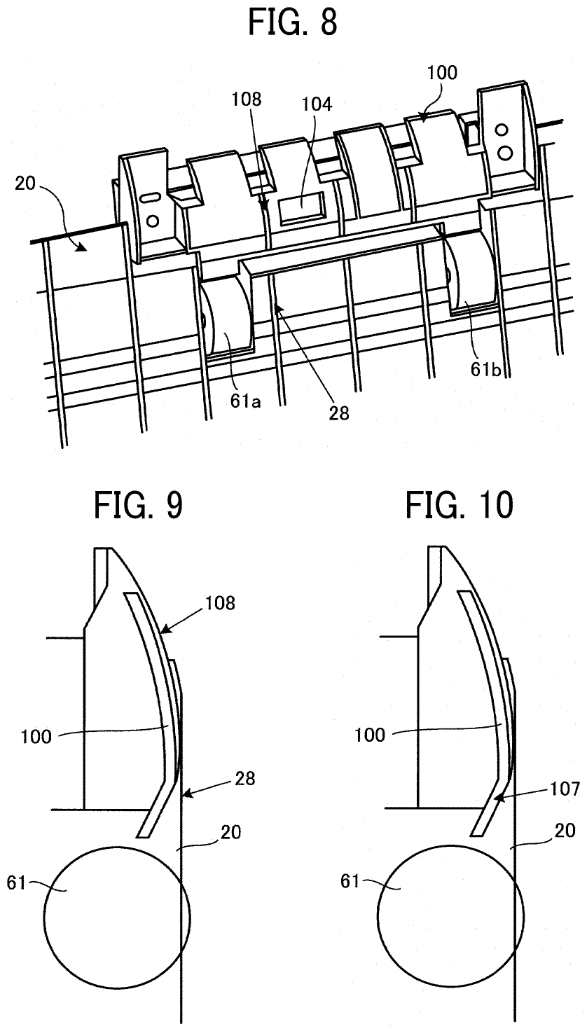

FIGS. 8 and 9 illustrate an arrangement of the ribs 28 of the first guide member 20a and the ribs 108 of the cover 100. FIG. 8 is a perspective view illustrating a part of the conveyance passage, and FIG. 9 is a schematic cross-sectional view of the vertical configuration of the conveyance passage.

In the recording medium conveyance direction, the rib 108 of the cover 100 downstream the first guide member 20a extends toward upstream from the rib 28 of the first guide member 20a. The height of the rib 108 in the cover 100 is lower than the height of the rib 28 of the first guide member 20a. That is, the top surface of the rib 108 is farther from the surface of the conveyance passage than the top surface of the rib 28. Setting the top surface of rib disposed on downstream side farther from the surface of the conveyance passage than the top surface of rib disposed on upstream side can prevent the occurrence of jam caused by the recording medium caught by the rib on the downstream side.

Preferably, the cover 100 has a surface along the conveyance passage of the recording medium. FIGS. 9 and 10 are schematic cross-sectional views of the vertical configuration of the conveyance passage. The cover 100 in the present embodiment has a curved surface along the surface of the conveyance passage as illustrated in FIGS. 9 and 10. When a part having a curved surface is downstream from the recording medium detector in the conveyance passage or when the bifurcating claw 8 has a curved surface facing the surface of the conveyance passage, the cover 100 having a surface shape along the curved surface can downsize the recording medium conveyance device.

The sheet ejection sensor 7 is easily affected by contamination by paper dust or the like in the image forming apparatus and is frequently maintained. According to the recording medium conveyance device of the present embodiment described above, removing the cover 100 on the conveyance passage enables easy access to the sheet ejection sensor 7 and improves the workability during replacement or maintenance. Therefore, the downtime of the image forming apparatus can be reduced, which improves the productivity.

Additionally, the cover 100 having a shape that enables arranging the cover 100 close to the bifurcating claw 8 can set the position of the sheet ejection sensor 7 accommodated in the cover 100 close to the bifurcating claw 8, and both improvement of detection accuracy and space saving can be achieved.

In the above-described embodiments, the maintenance part is the recording medium detector that is the sheet ejection sensor 7, but the maintenance part is not limited to this.

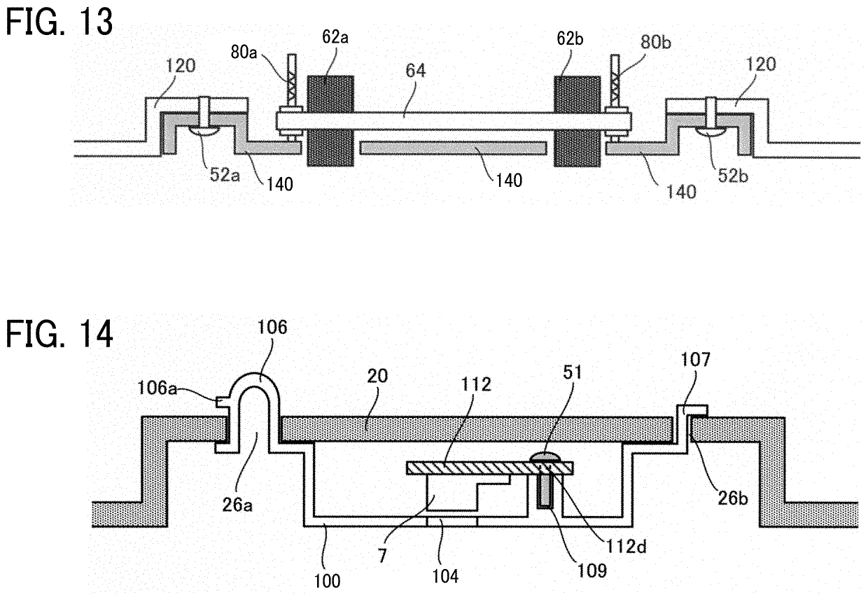

With reference to FIGS. 12 and 13, another embodiment is described. In the embodiment, the driven rollers 62 of the conveyance roller pair 6 are the maintenance parts disposed on the cover side guide 120. FIG. 12 is a perspective view illustrating the cover and the driven rollers 62 of the conveyance roller pair 6. FIG. 13 is a schematic cross-sectional view of the guide, the driven rollers 62 of the conveyance roller pair 6 and the cover in the recording medium conveyance direction.

As illustrated in FIG. 12, a roller cover 140 as the cover covers the driven rollers 62 of the conveyance roller pair 6 (that is, the driven rollers 62a and 62b) and exposes contact surfaces of the driven rollers 62 of the conveyance roller pair 6 that contact the recording medium.

As illustrated in FIG. 13, a shaft 64 supports the driven rollers 62 of the conveyance roller pair 6 (that is, the driven rollers 62a and 62b), and pressure springs 80 (that is, pressure springs 80a and 80b) press the shaft 64. The roller cover 140 is detachably attached to the cover side guide 120 by screws 52 (that is, screws 52a and 52b). Removing the roller cover 140 enables easy access to the driven rollers 62 of the conveyance roller pair 6 and the shaft 64 and easy maintenance and replacement.

The above-described embodiments are illustrative and do not limit the present disclosure. Thus, numerous additional modifications and variations are possible in light of the above teachings. It is therefore to be understood that within the scope of the present disclosure, the present disclosure may be practiced otherwise than as specifically described herein. Further, features of components of the embodiments, such as the number, the position, and the shape are not limited the embodiments and thus may be preferably set.

What is claimed is:

1. A recording medium conveyance device comprising:
a conveyance device cover being openable and covering a conveyance passage of a recording medium;
a pair of guides forming the conveyance passage,
the pair of guides including:
a cover side guide on the conveyance device cover; and
a body side guide separable from the cover side guide;
a maintenance part on at least one of the pair of guides; and
a removable cover configured to form a part of the conveyance passage and cover the maintenance part.

2. The recording medium conveyance device according to claim 1,
wherein the at least one of the pair of guides includes:
a first guide member including an upstream guide portion which is upstream from the removable cover in a recording medium conveyance direction; and
a second guide member including a downstream guide portion which is downstream from the removable cover in the recording medium conveyance direction,
wherein the first guide member, the second guide member, and the removable cover include a plurality of convex portions extending in the recording medium conveyance direction, and
wherein the removable cover has a notch configured to accommodate at least a part of a convex portion of the second guide member.

3. The recording medium conveyance device according to claim 2,
wherein the plurality of convex portions is arranged at intervals in a direction orthogonal to the recording medium conveyance direction, and
wherein the convex portion of the second guide member is disposed along a direction of a line extended from a convex portion of the first guide member and a direction of a line extended from a convex portion of the removable cover.

4. The recording medium conveyance device according to claim 2,
the plurality of convex portions of the second guide member is a plurality of ribs.

5. The recording medium conveyance device according to claim 2, further comprising a swing member,
wherein the second guide member is on the swing member, and the convex portion of the second guide member is accommodated in the notch.

6. The recording medium conveyance device according to claim 2,
wherein the second guide member is movably arranged so that the convex portion of the second guide member can swing in and out from the notch.

7. The recording medium conveyance device according to claim 2, further comprising a bifurcating claw,
wherein the second guide member is on the bifurcating claw configured to switch the conveyance passage of the recording medium.

8. The recording medium conveyance device according to claim 1,
wherein the removable cover has a surface along the conveyance passage of the recording medium.

9. The recording medium conveyance device according to claim 8,
wherein the surface is a part of the conveyance passage.

10. The recording medium conveyance device according to claim 9,
wherein the part of the conveyance passage has a curved surface.

11. The recording medium conveyance device according to claim 10,
wherein a notch is formed in the curved surface.

12. The recording medium conveyance device according to claim 1,
wherein the maintenance part is an electrical part.

13. The recording medium conveyance device according to claim 1,
wherein the maintenance part is a recording medium detector configured to detect the recording medium.

14. The recording medium conveyance device according to claim 1,
wherein the maintenance part is attached to the removable cover.

15. An image forming apparatus comprising
the recording medium conveyance device according to claim 1.

16. A recording medium conveyance device for an image forming apparatus, the recording medium conveyance device comprising:
a conveyance device cover being openable and covering a conveyance passage of a recording medium;
a pair of guides forming the conveyance passage,
the pair of guides including:
a cover side guide on the conveyance device cover; and
a body side guide having one end pivotably attached to the image forming apparatus and another end separable from the image forming apparatus;
a maintenance part on at least one of the pair of guides; and
a removable cover configured to form a part of the conveyance passage and cover the maintenance part.
